(19) United States
(12) Patent Application Publication
(10) Pub. No.: US 2019/0213677 A1
(43) Pub. Date: Jul. 11, 2019

(54) SYSTEMS AND METHODS FOR OPTIMIZING NETWORK TRANSACTION THROUGHPUT USING BATCHED TRANSACTION NETTING

(71) Applicant: WISE TRADIING TECHNOLOGIES, INC., Boston, MA (US)

(72) Inventors: Rohanna WISE, Sharon, MA (US); Benjamin ERNEST-JONES, Crestview, FL (US)

(21) Appl. No.: 15/863,472

(22) Filed: Jan. 5, 2018

(51) Int. Cl. G06Q 40/04; G06F 17/30; G06F 9/455

(52) U.S. Cl. CPC G06Q 40/04; G06F 2009/45562; G06F 9/45558; G06F 17/3028

(57) ABSTRACT

Systems and methods for optimizing netting operations of server device are disclosed. In one embodiment, a method is disclosed comprising receiving a plurality of transactions; building one or more currency pair positions based on the transactions; breaking down each of the currency pair positions into individual currency positions; netting the individual currency positions; identifying a plurality of high-priority currency pairs based on the netted individual currency positions; converting the high-priority currency pairs to an absolute value equivalent using current market rates; identifying a largest absolute value equivalent of the high-priority currency pairs; generating a foreign exchange order for the largest absolute value equivalent; and executing the foreign exchange order.

### COPYRIGHT NOTICE

This application includes material that may be subject to copyright protection. The copyright owner has no objection to the facsimile reproduction by anyone of the patent disclosure, as it appears in the Patent and Trademark Office files or records, but otherwise reserves all copyright rights whatsoever

### BACKGROUND

### Technical Field

This present disclosure relates generally to the field of interactive and automated network-based transaction execution, and in particular to interactive and automated systems and methods for netting network transactions and managing accounts and related information to optimize transaction throughput.

### Description of the Related Art

Current network systems continue to face an increase in the number of transactions to be processed by disparate client and end user devices. These increases are particularly onerous for automated transaction processing systems that process large volumes of similar or related transactions.

These systems suffer from the following core technical deficiencies. First, the systems incur delays, slower response times and increased processing and network overhead caused by the transmission of Forex orders and fulfillment thereof. Second, the systems fail to account for existing foreign currency managed within the account or by other accounts held by the same institution and thus fail to take advantage of otherwise accessible data. Last, the systems incur overhead costs and are thus more expensive to operate as a result of various fees associated with executing a Forex trade outside the system. The disclosed embodiments remedy these deficiencies via a specific arrangement of server-based components algorithms as described in more detail below.

As one example, currency transactions generally involve the use of a “currency pair” which represents a market conversion rate between two currencies. Currency pairs generally are presented by the notation CCY1/CCY2, wherein CCY1 represents the “base currency” and CCY2 represents the “quote currency.” Currency pairs are alternative referred to as Forex (or “FX”) rates. Each currency pair is associated with a market rate or bid price which represents the conversion rate between the base currency and the quote currency. For example, a currency pair between Euros and U.S. Dollars may be represented as “EUR/USD 1.5000.” In this example, one Euro may be traded (sold) for 1.5 U.S. Dollars. Conversely, one U.S. Dollar may be traded (sold) for approximately 0.667 Euro.

Frequently, accounts that involve currency trading are summarized by a “position” which refers to the quantity of currency required to fund a given transaction. If a position for a given currency is positive, an account is seeking to purchase that currency, usually in a given base currency. If a position for a given currency is negative, an account is seeking to sell that currency, usually to obtain a given base currency. Positive and negative positions for a given currency pair are inverses of one another. For example, if an account has a positive 100 EUR position, the account is seeking to purchase 100 Euro. If the market rate is 1.5, the account conversely has a −150 USD position based on the market rate.

Currently, most financial institutions manage multiple accounts. An account generally manages multiple asset classes (e.g., stocks, commodities, currencies, etc.). In general, numerous trades are executed on behalf of a given account throughout any given day. In order to finance these trades, each account may require currency in denominations other than the account's “base” currency (i.e., the default currency used by the account, commonly U.S. dollars in the United States). For example, if the account manager(s) decide to execute a trade in Japanese yen, the account must be fully funded in Japanese yen (JPY) prior to the purchase. Alternatively, the accounts may also execute Forex trades.

Current systems generally take a simplistic technical approach to ensuring an institution is properly funded in a foreign currency. For example, if a given account requires 50,000 JPY prior to a trade, the account manager(s) will instruct execution of a spot order to convert their base (non-JPY) currency into Japanese yen prior to executing the trade. Thus, the institution will transmit an order to a third-party foreign exchange to obtain the necessary foreign capital, incurring fees along the way.

### BRIEF SUMMARY

The disclosed embodiments remedy these deficiencies by describing systems, devices, and methods for automatically netting foreign exchange transactions. As described in more detail herein, the disclosure describes a system for automatically accessing real-time trading data from external third-party systems and queuing asset trades.

In one embodiment, a method is disclosed comprising receiving a plurality of transactions; building one or more currency pair positions based on the transactions; breaking down each of the currency pair positions into individual currency positions; netting the individual currency positions; identifying a plurality of high-priority currency pairs based on the netted individual currency positions; converting the high-priority currency pairs to an absolute value equivalent using current market rates; identifying a largest absolute value equivalent of the high-priority currency pairs; generating a foreign exchange order for the largest absolute value equivalent; and executing the foreign exchange order.

In another embodiment, a server device is disclosed comprising a processor; and a storage medium for tangibly storing thereon program logic for execution by the processor, the stored program logic comprising: logic for receiving a plurality of transactions; logic for building one or more currency pair positions based on the transactions; logic for breaking down each of the currency pair positions into individual currency positions; logic for netting the individual currency positions; logic for identifying a plurality of high-priority currency pairs based on the netted individual currency positions; logic for converting the high-priority currency pairs to an absolute value equivalent using current market rates; logic for identifying a largest absolute value equivalent of the high-priority currency pairs; logic for generating a foreign exchange order for the largest absolute value equivalent; and logic for executing the foreign exchange order.

### BRIEF DESCRIPTION OF THE FIGURES

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 illustrates a network system for netting currency orders according to some embodiments of the disclosure.

FIG. 2 illustrates an architectural and deployment diagram for a netting system according to some embodiments of the disclosure.

FIG. 3 illustrates a logical block diagram of a system for netting currency orders according to some embodiments of the disclosure.

FIG. 4 illustrates a network connection diagram between a system for netting currency orders and customer systems according to some embodiments of the disclosure.

FIGS. 5A and 5B illustrate a method for currency orders broken down by currency according to some embodiments of the disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

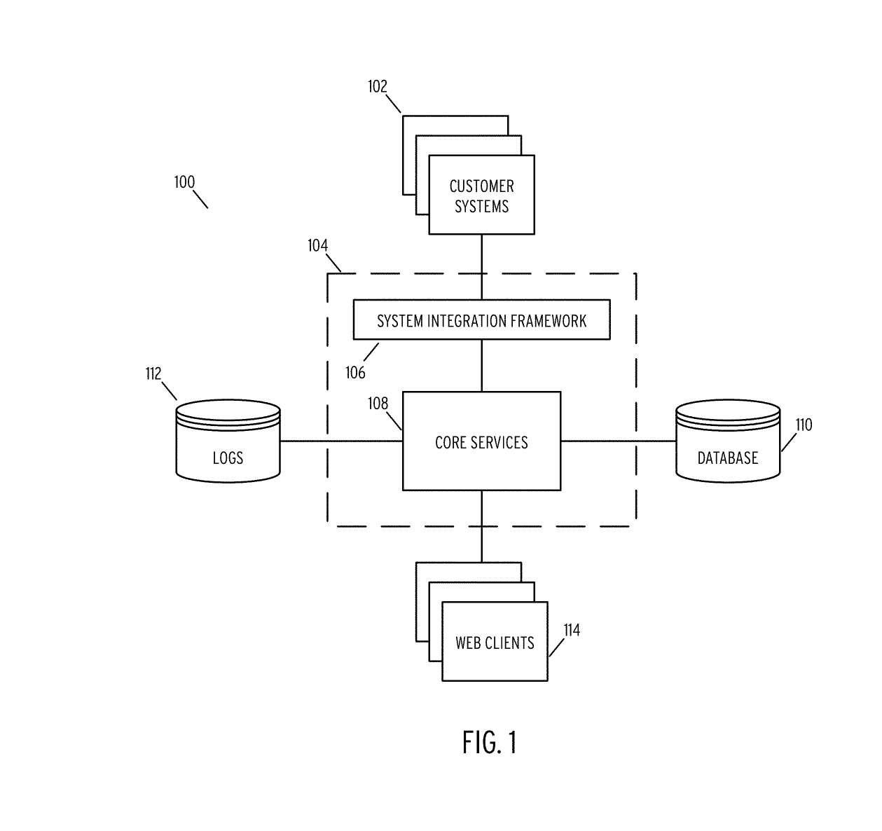

FIG. 1 illustrates a network system for netting currency orders according to some embodiments of the disclosure.

As illustrated, system 100 includes customer systems 102, web clients 114, netting system 104, logs 112, and database 110. Netting system 104 further includes a system integration framework 106 and core services 108.

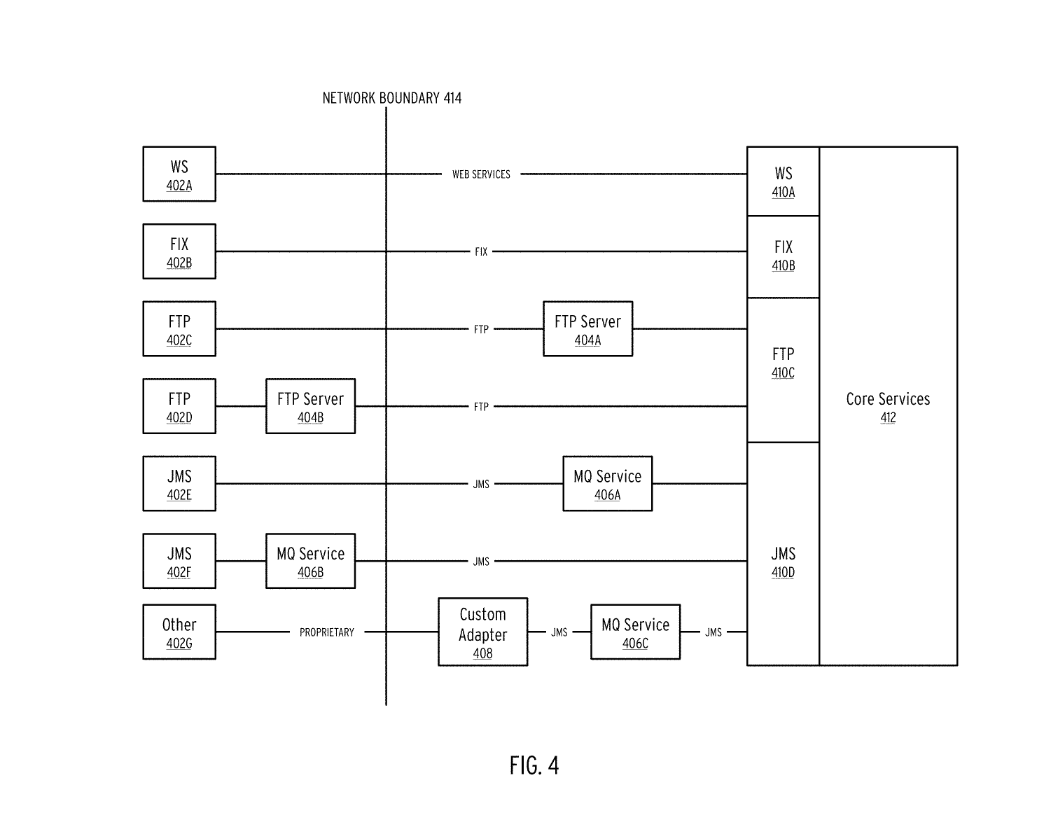

In the illustrated embodiment, customer systems 102 may comprise any number of financial systems operated by financial institutions or, more generally, firms that are involved in security trades or similar transactions. In some embodiments, customer systems 102 comprise entire network-based systems in their own right. In general, customer systems 102 transmit securities trades to netting system 104. Examples of protocols for facilitating these transmissions are discussed more fully in connection with FIG. 4, the disclosure of which is incorporated herein by reference in its entirety.

As illustrated, customer systems 102 transmit data (e.g., trades) to netting system 104 via system integration framework 106. In one embodiment, integration framework 106 is designed to integrate data feeds from customer systems 102 that may utilize disparate protocols. For example, one customer system may transmit data to netting system 104 via a web services protocol while another customer system may transmit data using a JMS protocol. In some embodiments, system integration framework 106 may additionally receive data from third-parties such as market rates from third-party liquidity providers. In one embodiment, system integration framework 106 provides integration points for various protocols as described in FIG. 4. One function of system integration framework 106 is to translate each of the messages in an input format into an internalized format for processing by core services.

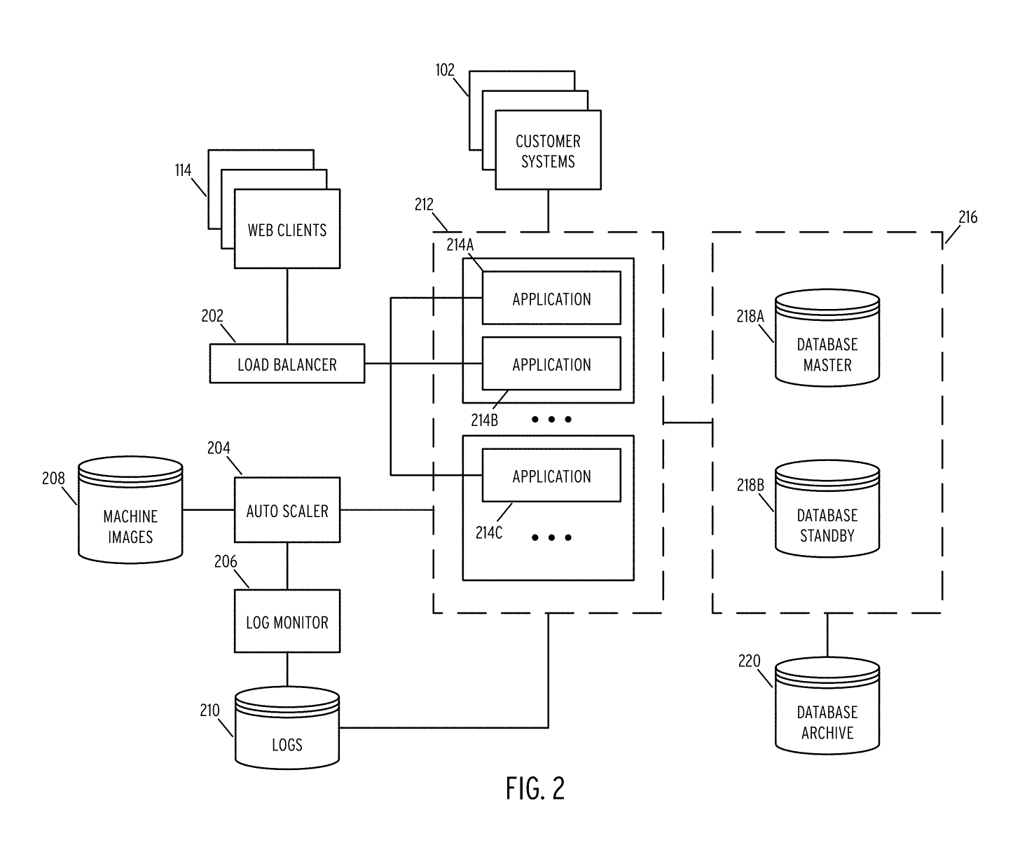

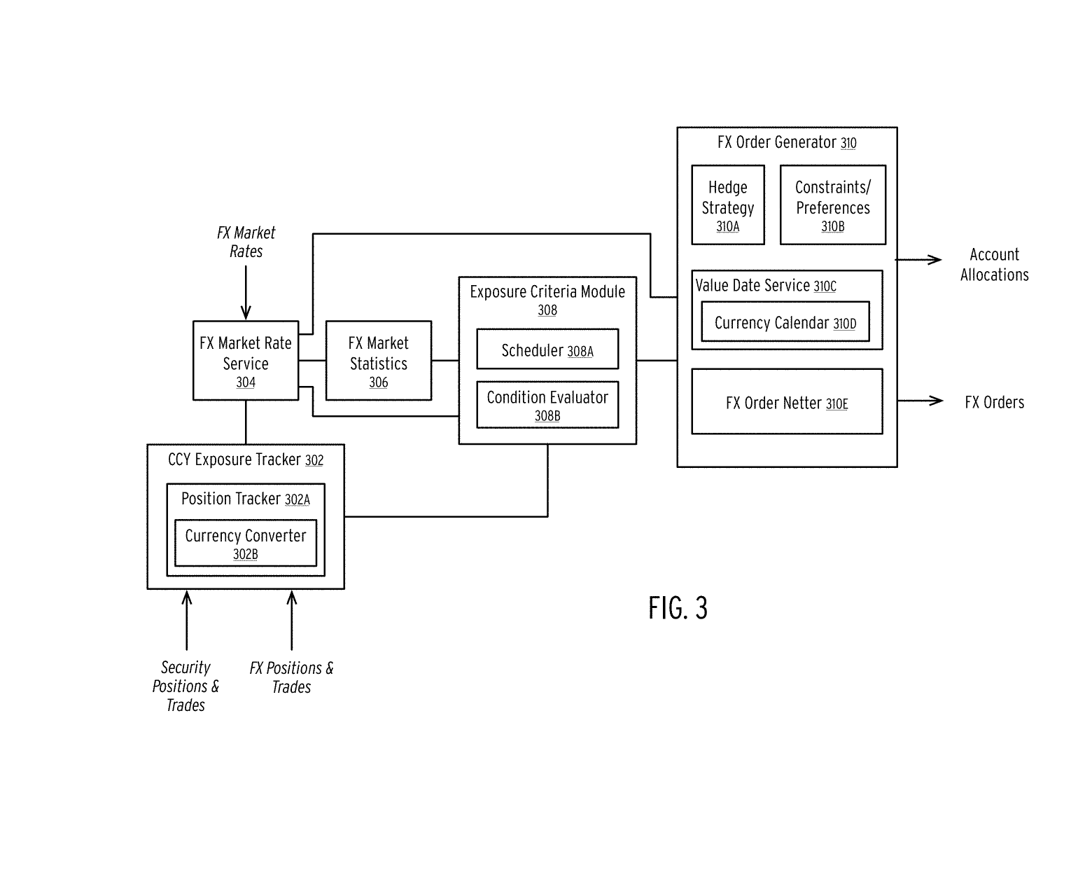

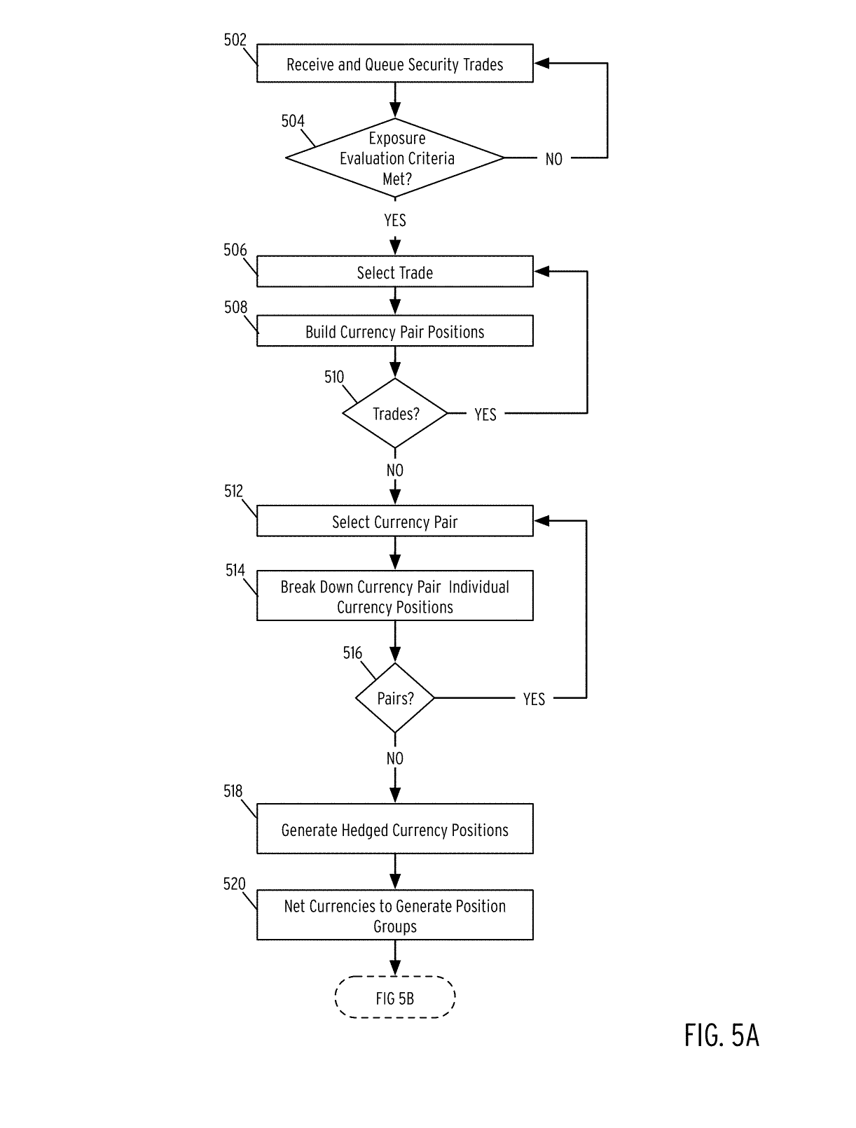

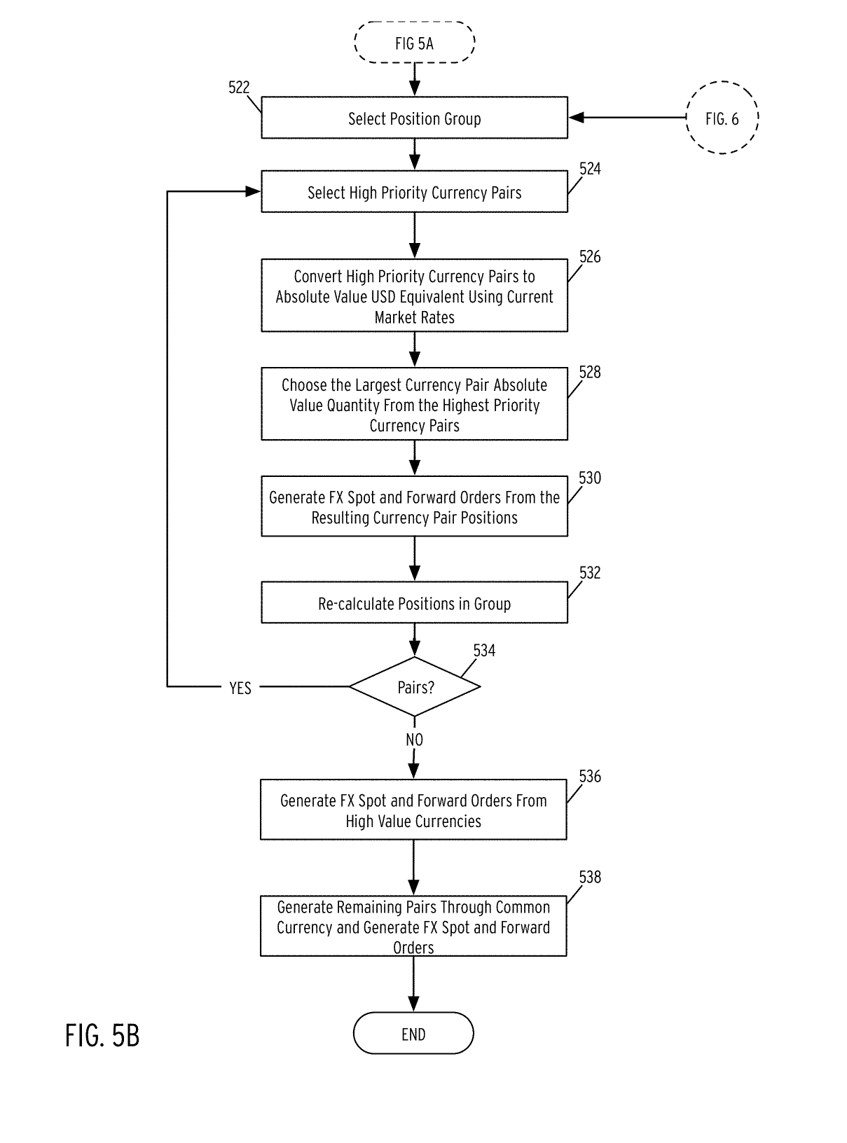

Messages from system integration framework 106 are transmitted over a network to core services 108. In one embodiment, core services 108 performs all processing on messages received via system integration framework 106. Details of specific processing performed by core services 108 are described architecturally in FIGS. 2 and 3 and functionally in FIGS. 5A and 5B, the details of which are incorporated herein by reference. Core services 108 are additionally communicatively coupled to one or more databases 110. In some embodiments, databases 110 may comprise relational databases (e.g., MySQL databases) or non-relational databases (e.g., MongoDB). In some embodiments, the databases 110 may comprise a plurality of varying types of databases. Core services 110 are additionally coupled to log storage 112 which stores logs generated during the processing of messages received from system integration framework 104.

Additionally illustrated in FIG. 1 are web clients 114. In one embodiment, web clients 114 comprise user computing devices that access the netting system 104 via a web-based interface. In one embodiment, netting system 104 may provide a web-based GUI to control the operation and parameters of the netting system 104 for a given firm.

FIG. 2 illustrates an architectural and deployment diagram for a netting system according to some embodiments of the disclosure. Customer systems 102 and web clients 114 are described in FIG. 1 and are substantially similar to the corresponding components depicted in FIG. 2. Disclosure of these components is not repeated herein but is incorporated by reference.

As illustrated, customer systems 102 communicate directly with one more applications 214A-C in application cluster 212. In the illustrated embodiment, applications 214A-C may be assigned a public IP address to enable connectivity between customer systems 102 and applications 214A-C. As illustrated, applications may be grouped into separate virtual private cloud (VPC) subnets. For example, applications 214A-B are organized into a first subnet while application 214C is organized into a second VPC subnet. Details of applications 214A-C are described more fully in connection with FIG. 3.

In some embodiments, applications 214A-C are organized as auto-scaling groups of machines. Specifically, applications 214A-C may be deployed on an infrastructure-as-a-service (IaaS) provider that allows for auto-scaling of applications 214A-C depending on system load. Specifically, the system may include logs 210 that monitor the operation of the system at the network level to monitor system usage and overruns. Thus, applications 214A-C continually transmit status logs to log storage 210. Log monitor 206 periodically accesses logs 210 to determine whether any application 214A-C is at capacity as well as determining whether the applications 214A-C combined are running a maximum capacity (e.g., both computationally and from the standpoint of network bandwidth).

Log monitor 206 transmits the results of this analysis to auto scaler 204 which may comprise a standalone computing device or image. As an example, log monitor 206 may determine that applications 214A-C are operating at 95% of all computing resources and thus are in danger of refusing requests. In response, log monitor 206 transmits an alarm to auto scaler 204 that the system is about to reach capacity.

In response, auto scaler 204 retrieves a machine image from machine image database 208. In one embodiment, database 208 stores images of applications 214A-C. In one embodiment, a machine image comprises a listing of operating system and application software (and configuration data) needed to provision a new machine. For example, a machine image may comprise an AMAZON machine image (AMI) of an application 214A-C. In response to detecting a need for additional machines, auto scaler 204 retrieves a machine image from database 208 and provisions a new virtual machine (i.e., similar to applications 214A-C).

In addition to scaling up applications, log monitor 206 is additionally configured to monitor usage of applications 214A-C to identify when any applications 214A-C are operating significantly below capacity. For example, log monitor 206 may identify when a given application 214A-C has operated at near 0% for an extended period of time. In this scenario, auto scaler 204 may destroy a virtual machine running the under-performing application.

Applications 214A-C store the results of processing data in database master 218A and database standby 218B. In one embodiment, the system may synchronize writes to database master 218A with database standby 218B such that database standby 218B maintains a live copy of database master 218A. In the event of a failure of database master 218A, the system may re-route all reads/writes to database standby 218B to enable continuous operation of the system. Once database master 218A is returned to an operational status, the system may synchronize all changes to database standby 218B (e.g., using an oplog or other structure) to return control to database master 218A.

The system additionally includes a database archive 220. In some embodiments, database archive 220 may similarly be kept in sync with database 218A-218B to enable disaster recovery. Alternatively, or in conjunction with the foregoing, database archive 220 may be “write only” to ensure that database archive 220 includes all states of the databases 218A-218B (i.e., to recovered deleted data, etc.).

As illustrated, web clients 114 interact with applications 214A-214C via load balancer 202. In some embodiments, load balancer 202 ensures that client requests are routed to available applications 214A-C in a distributed fashion, ensuring that no single application 214A-C is overwhelmed by client requests.

Additionally, as illustrated in FIG. 2, applications 214A-C and databases 218A-B may be placed in separate security groups 212 and 216, respectively. In some embodiment, these security groups control traffic into and out of the given group. Thus, group 212 may allow for external network requests while group 214 may only allow for traffic from a VPC subnet.

FIG. 3 illustrates a logical block diagram of a system for netting currency orders according to some embodiments of the disclosure.

As illustrated, the system receives inputs including FX market rates, security positions/trades, and FX positions/trades and generates outputs of account allocations and FX orders. In one embodiment, these inputs and outputs are all handled by the system integration framework discussed previously.

The system includes a currency (CCY) exposure tracker 302 (also referred to as an “exposure tracker”) which receives security positions/trades and FX positions and trades from the system integration framework via position tracker 302A and currency converter 302B. In one embodiment, tracker 302A monitors various external updates through the system integration framework in order track currency exposure, positions, and derived statistics.

In one embodiment, tracker 302A maintains asset currency exposure positions for each account and security, based on a start of day batch and intra-day asset positions updates for each account and security as well as intra-day asset trade updates per account and security. In some embodiments, tracker 302A is not required to monitor actual security positions but rather only net currency exposure (i.e., quantity multiplied by price per update) per account and security. Additionally, tracker 302A may maintain the current status of all FX order recommendations, including the order itself, order updates, and account allocations, based on intra-day submitted FX order recommendation updates and intra-day FX order updates. Tracker 302A may additionally maintain account forward positions associated with hedging asset trades, based on a start of day batch and intra-day forward position updates and intra-day FX order hedging updates. In alternative embodiments, there may be more than one entry for each account and currency if positions are held at different prices. Alternatively, or in conjunction with the foregoing, the tracker 302A may maintain account cash positions associated with funding asset trades, based on intra-day FX order funding updates. Alternatively, or in conjunction with the foregoing, the tracker 302A maintains settled cash repatriation positions for each account, based on a start of day batch and intra-day cash position updates and intra-day FX order repatriation updates. Alternatively, or in conjunction with the foregoing, in order to enforce configured account exposure limits and accurately select target brokers for FX order recommendations, the tracker 302A shall maintain account liquidity provider current exposure levels, based on a start of day batch and intra-day account liquidity provider exposure updates and intra-day FX order updates. In addition, the tracker 302A may maintain an account's working exposure quantity to account for exposure that is part of orders not yet executed, but that have been submitted and are currently pending execution in an external FX order management system (OMS).

Currency converter 302B receives FX market rates from one or more liquidity providers through the system integration framework and via FX market rate service 304. In the case where more than one liquidity providers is streaming FX market rates, the rates from different providers can be combined into a single view. Currency converter 302B may use a set of generic liquidity providers by default with each new organization. In the case where an organization is willing and able to provide access to its own organization FX market rate feeds, converter 302B may be configured to use those rates instead through the system integration framework for that specific organization. A system wide configurable setting may be utilized to determine the method by which FX market rates are consumed by various services (e.g., MidPrice, TOB, VWAP). Various FX market rate statistics per currency pair are also collected by FX market statistics module 306 for consumption by various system services, including market volatility (i.e., volume weighted Average True Range (ATR) and Average Percentage Range (APR) of market rates) using system wide settings to indicate time and volume values (e.g., 20 evenly spaced samples across configured time period).

The system additionally includes exposure evaluation criteria module 308 which include scheduler 308A and condition evaluator 308B. In general, exposure evaluation criteria module 308 is configured to monitor exposure and hedging positions received via tracker 302 and identify when FX orders should be generated based on the positions and market rates. That is, exposure evaluation criteria module 308 monitors the system to determine when to trigger order recommendations for hedging, funding, and repatriating specific accounts and currencies based on an evaluation of currency exposure.

Each category of order generation (hedging, funding, repatriating) may include one or more active triggers. In one embodiment, active triggers for a given category shall not interfere with any active trigger for any other category, and concurrent triggers for any given category continue to make a single trigger active for that category. In one embodiment, each trigger continues to be active until either all target positions are reached in full or all remaining target positions are too small to execute with any broker.

Exposure evaluation criteria triggers may include schedule, condition-based, manual, cash repatriation, and/or external triggers. Schedule triggers comprise triggers for hedging and funding across all organization accounts and currencies based on one or more of a variable list of multiple exact times within a day and/or a recurring period and a value indicating the frequency of recurrences according to that period. Schedule triggers may additionally be wholly enabled or disabled by an organization. Condition-based triggers may include (1) portfolio exposure greater than a specified percentage; (2) market ATR volatility greater than a specified value; (3) market APR volatility greater than a specified percentage; or (4) similar triggers. Manual triggers may comprise users manually triggering hedging, funding, and repatriation either organization wide across all currencies, or per account and per currency. External triggers may include a funding or hedging trigger generated based on exposure positions generated from incoming FX orders rather than asset exposure.

The system additionally includes an FX order generator 310. As illustrated, the output of the generator 310 are account allocations and FX orders which may be forwarded to external systems (e.g., back to firms or to liquidity providers) via the system integration framework.

Generator 310 includes hedge strategy storage 310A. In one embodiment, hedge strategy storage 310A stores an organizations hedging strategy rules (e.g., pre-define hedge ratios). In some embodiments, hedge strategy storage 310A may additionally include algorithm hedge strategy rules.

Generator 310 additionally includes constraints/preferences storage 310B. In one embodiment, constraints/preferences storage 310B may include constraints or preferences regarding a specific system-defined constraint such as hedge ratios, exposure limits, netting restrictions, etc. In some embodiments, constraints/preferences storage 310B may additionally include specific constraints applied to currencies or currency pairs. Alternatively, or in conjunction with the foregoing, constraints/preferences storage 310B may additionally include constraints to be applied to specific liquidity providers (e.g., credit limits etc.).

Generator 310 additionally includes a value date service 310C which includes a currency calendar 310D. Value date service 310C enables the calculation of spot and forward order dates validated against a currency holiday calendar 310D. In some embodiments, the calendar 310D may be maintained by a third-party service provider.

Generator 310 additionally includes an FX order netter 310E which performs the operations discussed in more detail in the description of FIGS. 5A and 5B, including the examples following said descriptions.

FX order netter 310E combines position update requirements based on the relevant exposure criteria trigger including required funding position updates (e.g., derived from the 100% net positions of total asset exposure, and executed, working, and rejected fund position quantities), required hedging position updates (e.g., derived from the net positions of total asset exposure, and executed, working, and rejected hedge position quantities, up to specified hedge ratios for each account and currency), and required repatriation position updates (e.g., derived from the 100% net positions of total cash repatriation positions, and executed, working, and rejected repatriate position quantities).

Groups of combined position update requirements may be generated separately from the primary combined group for each configured netting-restricted account. In the case of multiple forward value dates, separate groups of combined position update requirements may be generated for each value date.

FX order netter 310E generates FX order recommendations based on combined position update requirements according to one of the following methods: (1) per currency pair per account; (2) net per currency pair across accounts; and (3) net across account currencies. In one embodiment, per currency pair per account comprises generating a separate currency pair order for each separate account position. In one embodiment, net per currency pair across accounts comprises generating a single netted order per currency pair across all account positions for that currency pair. In one embodiment, net across account currencies comprises generating the optimal combination of netted orders by combining and crossing all available account positions.

FX order netter 310E allows the user to select which order generation method to use to meet the needs of each organization. In one embodiment, forward hedge orders are generated to be settled at the end of the current month. Alternatively, or in conjunction with the foregoing, spot and forward value dates are calculated and validated against a currency holiday calendar maintained by a trusted third party data vendor (as discussed above). In one embodiment, the broker for each order is selected by the FX order netter 310E using the maximum notional amount allowed for each order according to each underlying account's broker exposure limits and current levels of exposure per broker.

In one embodiment, FX order netter 310E submits each generated FX order recommendation in the form of a message sent to the system integration framework to be forwarded on to the appropriate external system for execution. In cases where order recommendation quantities must be derived using market rates, the user may choose between generating all FX orders from a single exposure criteria trigger and sending the full list in batch to the system integration framework, or only generating one order at a time, waiting to generate remaining orders until each subsequent order recommendation is in a final state, in order to generate each order using accurate positions based on confirmed trade quantities and prices.

FIG. 4 illustrates a network connection diagram between a system for netting currency orders and customer systems according to some embodiments of the disclosure.

As illustrated in FIG. 4, various protocols may be used on either side of a network boundary 414. On the left of boundary 414 are client-side integration points (402A-402G) while on the right are server-side integration points (410A-410D). Integration points 410A-410D may be part of a system integration framework which translates requests for core services 412. The system integration framework and core services 412 are described in more detail in the descriptions of FIGS. 1 through 3 and that description is not repeated herein but is incorporated by reference.

As illustrated, some protocols may connect clients to the server directly. For example, clients may connect to server via a web services (e.g., REST, SOAP, etc.) connection via integration points 402A and 410A. Similarly, clients may connect to the server via a Financial Information eXchange (FIX) protocol via integration points 402B and 410B.

For File Transfer Protocol (FTP) transfers, a client may include both a transmission integration point 402C and a receiving integration point 402D. As illustrated, the client-side integration point 402C transmits data via an FTP client to FTP server 404A which routes the received files or messages to the FTP integration point 410C. Conversely, when sending data, the server transmits FTP data to client-side FTP server 404B which routes the returned data to an FTP endpoint 402D.

A similar architecture (using intermediary servers) is used for the Java Message Service (JMS) protocol. However, instead of file servers, the system uses message queue (MQ) services 406A and 406B to broker messages between the devices.

Finally, the system may support any other protocol used by the client device via integration point 402G. In this case, the server may be configured with a custom adapter 408 that translates messages (e.g., proprietary formatted messages) into a standard MQ message via MQ service (406C). In one embodiment, communications between custom adapter 408, MQ service 406C, and JMS integration point 410D may utilize the JMS protocol, although other protocols may be used.

FIGS. 5A and 5B illustrate a method for currency orders broken down by currency according to some embodiments of the disclosure.

In step 502, the method receives and queues security trades.

As discussed previously in FIGS. 1 through 4 and the accompanying description, the method may receive security trades from third-party customer systems. In some embodiments, the method may receive these trades via one or more of a web service (e.g., REST-based service), FIX, FTP, JMS, or proprietary data protocol

Although many of the examples below are discussed primarily in the context of capital markets, any type of firm activity that impacts an organization's foreign exchange exposure may be used as security trades. Alternatively, or in conjunction with the foregoing, a security trade includes any activity that affects the currency exposure of a firm or organization. For example, and without limitation, security trades may include security position resets, security trades, subscription redemptions, international resource purchases, etc. In one embodiment, a security trade may refer to a purchase, sale, or trade of an asset. For example, a security trade may comprise a stock or commodity purchase, sale, or trade. In one embodiment, a security trade may refer to a non-capital markets trade. For example, a security trade may include transactions relating to supply, distribution, and operating expenses. In some embodiments, the security trade may be conducted in a foreign currency.

While in some embodiments, trades received in step 502 are new trades, alternatively, or in conjunction with the foregoing, the trades in step 502 may comprise previously received (and already queued) trades.

In step 504, the method determines if exposure evaluation criteria are met.

An exposure evaluation criterion comprises a rule configured to trigger further processing by the method. In one embodiment, an exposure evaluation criterion is a function of a currency or market condition. For example, an exposure evaluation criterion may be set corresponding to the detection that USD/CAD market ATR volatility exceeds a predetermined threshold (e.g., 1.5 pips). As another example, an exposure evaluation criterion may be set corresponding to the detection that GBP/USD portfolio exposure exceeds a ratio against a target of 500M (i.e., the exposure of a portfolio is more than 80% of a target). Alternatively, or in conjunction with the foregoing, an exposure evaluation criterion may comprise a scheduled interval.

As another example, an exposure evaluation criterion may include a manual interaction of a user with a user interface. In this example, the user may manually trigger the exposure evaluation criterion in step 504. As another example, exposure evaluation criterion may include immediate execution criteria. In this example, the method may receive a batch of exposure events (e.g., positions, trades, etc.) and may trigger the exposure evaluation criterion immediately in response to these events. In another example, the exposure evaluation criterion may comprise a schedule of planned triggers (e.g., once every Wednesday for three weeks). In another example, exposure evaluation criterion may include triggering if a given accounts position is a configured distance away from a preset target. As another example, an exposure evaluation criterion may include a news-based trigger. That is, a separate system may monitor one or more external news feeds and execute a trigger upon determining that reported events affect currency exposure or hedging (e.g., news regarding companies involved in trades).

In some embodiments, the exposure evaluation criterion may additionally include multiple criteria in an ordered list of criteria. In this embodiment, one criterion may override others and vice versa. For instance, a first criterion may comprise a weekly trigger while a market volatility trigger may override the weekly trigger depending on market conditions.

In one embodiment, the method stores exposure evaluation criteria in a database of exposure evaluation criteria. In this embodiment, each exposure evaluation criterion is associated with a customer. Alternatively, or in conjunction with the foregoing, an exposure evaluation criterion may be associated with other database entries such as currencies, individual accounts, individual users, etc. As illustrated, the method may continue to queue security trades until one or more of the exposure evaluation criteria is met.

In step 506, once the method determines that one or more exposure evaluation criteria are met, the method selects a trade.

As discussed above, while the term trade is used and explained primarily in the context of capital markets, the method is not intended to be limited solely to capital markets. In some embodiments, each trade is associated with a security or other assets (e.g., “buy MICROSOFT”). Additionally, each of the trades received in step 502 has a list of accounts associated with the trade. As used herein, an account refers to a financial account managed by a customer. For example, an account may comprise an investment account or other financial holding of the customer. That is, an account may correspond to an investment account wherein a trade is executed on behalf of the investment account (e.g., a mutual fund or similar structured investment account).

In one embodiment, the method retrieves a listing of accounts based on a customer associated with the queued trades. Alternatively, or in conjunction with the foregoing, the method may identify accounts solely based on the queued trades. For example, each queued trade may include details regarding the trade (e.g., the asset type to be purchased/sold, the amount, etc.) and may also store an identifier associating the trade with the specific account. In some embodiments, the relationship between a trade and a customer may be extracted based on first identifying the account and then identifying the customer associated with the count (e.g., via a “has many through” type relationship). In some embodiments, a base currency may be extracted from a list of accounts and base currency mappings. Alternatively, or in conjunction with the foregoing, the base currency may be extracted from the trade itself given that the trade includes a base currency and one or more account identifiers. In one embodiment, any trade that affects exposure, the trade includes a list of accounts and how the trade is broken down between accounts.

In step 508, after selecting an account, the method builds currency pair positions for the selected trade.

In one embodiment, the method analyzes each trade and loops through each account, generating a listing of currency pair positions for each account. The method may then combine the currency pair positions across accounts. As used herein, combining does not refer to netting currency pair positions. Rather, combining refers to combining a list of trades to be netted in future steps. Prior to building a currency pair, the method may identify a base currency for each of the accounts involved in the trade. Since a trade additionally includes a transaction currency (e.g., “buy MICROSOFT in USD”), currency pairs of “base currency” and “asset currency” may be built for each account involved in a trade. Note that in some embodiments, the base currency of the account may be equal to the base currency of the trade. If this scenario is identified, the method may ignore the account involved. In some embodiments, the trade may include a single account or multiple accounts. In some embodiments, the method may offset buy and sell transactions within a single account to perform internalized netting prior to generating a listing of trades that must be netted.

For example, Account A may include two trades involving EUR/USD transactions (buy and sell) while Account B may include a transaction involving a EUR/USD and a USD/JPY transactions (both buy). In this example, the method may combine Account A's EUR/USD positions into a single position and may retain Account B's two positions. In this manner, the method builds a table of unique currency pairs and each accounts position with respect to each currency pair.

In step 510, the method determines if any trades remain to be analyzed and, if so, continues to build currency pairs for each remaining trade and account(s).

In step 512, the method selects a currency pair identified in step 508. As discussed previously, the previous steps may result in one or more currency pairs involved in the queued security trades analyzed by the method after the exposure evaluation criteria is met. As described in more detail below, the method proceeds to analyze each of these currency pairs in order to net the trades across accounts.

In step 514, the method breaks down each currency pair into individual currency positions.

In general, the method extracts each currency position using the currency pairs. For example, a EUR/USD position may be broken down into a Euro position and a USD position. Note that in one embodiment, the method may defer using market rates until later processing steps. For example, the market rate may be identified in step 530 when executing the spot or forward orders. In this embodiment, the method in step 514 only breaks down currency pairs without consideration of market rates.

In some embodiments, breaking down a currency pair into individual currency positions may be done using market rates. In this embodiment, the method first retrieves the amount of the base currency to be purchased or sold and calculates the corresponding currency based on market rates. For example, if a trade involves a purchase of 1500 EUR/USD and the market rate for EUR/USD is 1.1200, the method calculates that the corresponding USD position is −1680. In one embodiment, the method may also calculate a base total for each account, wherein the base total is calculating according to a base currency associated with each account. In one embodiment, the method retrieves current market rates from a third-party liquidity provider. As used herein, a market rate refers to the conversion rate of various currencies involved in a trade.

In step 516, the method determines if any currency pairs remain and continues to break down each currency pair for all remaining currency pairs.

In step 518, the method generates additional currency positions for any hedge positions.

In some embodiments, the method may generate spot orders to fund security trades. For example, a given trade may represent a purchase of a given stock at a given price. To fulfill the currency requirements for this trade, the method generates spot orders to ensure liquidity in the trade currency. Alternatively, or in conjunction with the foregoing, the method may generate forward orders to hedge against certain trades. For example, a given account may have a defined hedge rate (e.g., 70%). In some embodiments, hedging rates may be configured per-currency, per-security, or per-account. In some embodiments, the hedge rate may include not just a target but also a range of drift (±1%) from the target to prevent the generation of multiple smaller orders. The use of hedged positions is described more fully in FIG. 5B and the accompanying description.

In some embodiments, the method may additionally generate proxy hedge positions. As used herein, a proxy hedge position comprises a derivative FX positions generated based on an existing currency position. For example, the method may be configured to generate FX orders in a currency other than a currency involved in a currency pair. For example, a Canadian company may be listed on the Australia stock exchange. If an account base currency is USD, the resulting pair is AUD/USD. However, the method may be configured to generate forward orders for USD/CAD based on the knowledge that the underlying trade is primarily affected by fluctuations in the Canadian dollar. In some embodiments, proxy positions may be generated automatically based on analysis of the organizations or assets involved in a trade. For example, the method may utilize a table mapping corporate entities to domiciles or loci of activities and generate one or more proxy hedge positions based on this mapping. In another embodiment, each entity involved in a trade may additionally be associated with one or more other entities related to the entity involved in the trade. In this manner, the method may generate proxy hedge positions based on the relationships between entities. For example, an entity involved in a trade may be owned by an entity located in another country, that country's currency may be utilized for a proxy hedging.

After generating any additional currency positions based on hedge rates and ranges in step 518 (or proxy hedge positions), the method may then combine the exposure-based currency positions generated in step 514 with the hedged currency positions generated in step 518 to create an combined list of currency positions.

In step 520, the method nets each currency to generate one or more position groups.

As described above, after step 516, the method may combine each account's position for each identified currency. For example, if an account's position is −200 EUR and −50000 JPY (at market rates, +224 USD and +417.1185451, respectively); the combined currency position for such account would be −200 EUR, −50000 JPY, and 641.1185451 USD, reflecting the accounts position in USD to facilitate the EUR and JPY trades.

In one embodiment, the method may perform this netting for each account individually. Next, the method may combine the netted positions for each account to obtain a total position amount for each currency across accounts. Thus, after step 518, the method may obtain a single position for each currency, the position combining each individual account position.

As part of step 518, the method may additionally report any internalized allocations determined as a result of netting currencies across accounts. In one embodiment, an internalized allocation comprises a resolution of some or all of an accounts position using the position of another account.

For example, after combining currency pairs, Account A may have a position of 1500 USD while Accounts B and C may have positions of −200 and −219.9599466 USD, respectively. In this example, when the method combines the total USD position (1080.040053), the method may report an allocation of −200 and −219.9599466 USD to Accounts B and C, respectively, and an allocation of 419.9599466 to Account A. Thus, instead of placing an order on the market, the method internalizes orders to the extent that those orders may be filled using other account positions. In this manner, the method avoids the time and cost expenditures associated with external orders.

Note that the above description of steps 502 through 520 are described primarily from a position where the method begins with no previously queued trades. However, in many embodiments, the method may start in step 502 with many existing and/or pending trades. In this embodiment, the method may have already executed one or more FX trades and any incoming trades must be considered in the context of previous FX orders when calculating a position. For example, a given trade or set of trades may result in an exposure of 10 EUR/USD. However, previous orders may have already been sent for 2 EUR/USD, thus the total exposure is 8 EUR/USD.

In some embodiments, netting currencies may be further based on account-level netting restrictions. In these embodiments, account-level netting restrictions may include limitations on credit limits with established brokers used by a given account. In this example, each account may have a set credit limit for one or more brokers and the system may continue to execute trades until reaching that credit limit. In some embodiments, the method may additionally route trades to a given brokerage based on analyzing credit limits for an account at each brokerage. In another embodiment, the method may track and organizational credit limit. In another embodiment, the method may further utilize a list of accounts that should not be netted. In this embodiment, trades associated with those accounts may be excluded from further processing. In another embodiment, the method may analyze a list of accounts that place restrictions on the types of trades that may be netted. For example, an account may restrict netting with so-called “sin” trades (e.g., trades involving alcohol or tobacco). In this example, those trades may be excluded from netting or may only be netted with non-sin trades.

In step 522, the method selects a position group.

In some embodiments, the method may perform the aforementioned netting steps across all accounts associated with the queued trades. Alternatively, or in conjunction with the foregoing, the method may also filter accounts that restrict cross-account netting. In this embodiment, the method may perform the remaining steps of the methods multiple times; that is, once for netted accounts and once for each non-netted account. Thus, in some embodiments, multiple position groups may exist for netted accounts and non-netted accounts.

In step 524, the method selects the highest priority currency pairs.

In one embodiment, each currency pair may be associated with a priority. In one embodiment, this priority may be set by the customer and may indicate a customer's preference for a currency pair with respect to other currency pairs.

In step 526, the method converts the selected high priority currency pairs to absolute value USD equivalent using current market rates.

In one embodiment, the method may calculate a maximum quantity of each currency pair according to the following formula:

$$quantity = \{ \begin{matrix}\vert \frac{{Q}_{p}}{r} \vert , & if \vert {B}_{p} * r \vert > \vert {Q}_{p} \vert \\ {B}_{p} , & otherwise\end{matrix} \qquad EQUATION 1$$

In Equation 1, Qₚ represents the combined positional quantity with respect to a quote currency, Bₚ represents the combined positional quantity with respect to a base currency, and r represents the market rate for the associated currency pair.

Thus, if the currency pair is EUR/USD, the market rate is 1.12, the combined EUR (base) position is 100, and the combined USD (quote) position is −100, the quantity of EUR/USD would be 89.28571429. Correspondingly, the amount in USD would be 100. Specifically, the condition in Equation 1 evaluates to true (i.e., 112>100), thus the maximum quantity would correspond to the USD buying power of the combined positions (100 divided by the market rate).

Conversely, if the currency pair is EUR/USD, the market rate is 1.12, the combined EUR (base) position is 100, and the combined USD (quote) position is 9000, the quantity of EUR/USD would be 100. Correspondingly, the amount in USD would be 112. Specifically, the condition in Equation 1 evaluates to false (i.e., 112<9000), thus the maximum quantity would correspond to the EUR buying power of the combined positions (100 multiplied by the market rate).

In step 528, the method chooses the largest currency pair absolute value quantity from the highest priority currency pairs.

As described above, multiple high priority currency pairs may exist in a given position group. In this step, the method selects, from the equal priority pairs, the given currency pair quantity that results in the largest quantity transaction.

In step 530, the method generates an FX spot or forward order based on the pair selected in the previous step.

In one embodiment, the method queues the determined FX order for batch execution at the end of the method. In an alternative embodiment, the method may immediately execute the FX order in step 530.

As described in more detail herein, an FX spot order may be placed if the method is being utilized to manage currency exposure. Alternatively, or in conjunction with the foregoing, a forward order may be utilized if the method is being utilized to hedge currency risk. In some embodiments, hedging and exposure may be configured to be active by a user of the method.

In step 532, the method re-calculates the currency positions within the group based on the determined FX order. In one embodiment, recalculating the currency positions comprises offsetting the original currency positions by the amount of the FX order determined in step 530.

In step 534, the method determines if any currency pairs remain.

In one embodiment, after creating the first FX order, the method may determine if any currency pairs can be generated after executing the first trade. As illustrated in more detail in the examples presented herein, the method may analyze the positions across accounts and again build all possible high-priority currency pairs (step 522) and proceed to performs steps 524 through 532 again. In this manner, the method continually builds high-priority currency pairs and performs steps 524 through 532 until no more currency pairs can be built from a set of account positions.

Upon determining that no more pairs can be generated from the account positions (e.g., only a single position for a single currency remains), the method, in step 536, may generate FX spot and forward orders for high value currencies remaining in the list of positions.

After processing high-priority currency pairs in steps 524-534, positions may still exist that could not be fulfilled with high-priority currency pairs. For example, the method may still have a list of currency positions for currencies other high value currencies (e.g., Sterling, Euro, etc.). In general, a high-value currency is a currency that is significantly liquid and may be easily exchanged. In step 536, the method may pair up any other currency with those high-value currencies and perform steps 526 through 532 for those generated pairs.

In step 538, the method generates any remaining pairs through a common currency and generates spot and forward FX orders.

In some embodiments, after converting high-priority currency pairs and high-value currency positions in FX spot and forward orders, the method may then be left with one or more currencies positions that are not convertible with liquid currency pairs. For example, after the processing in steps 524 through 536, the method may be left with a Mexican peso position and a Korean won position. In this case, there is no liquid exchange between pesos and won. In this scenario, the method (in step 538) “crosses” the peso and won position with a common currency (e.g., the U.S. dollar). The result would be a USD/MXN order and a USD/KRW order.

In some embodiments, the selection of high priority currency pairs and/or high value currencies may be identified by a user of the method. However, in other embodiments, the selection of both high-value currency pairs and high-value currencies may be generated based on analyzing market positions and strength of each pair or currency. In this embodiment, the method may analyze a third-party data feed of currencies and/or pairs to automatically rebalance the ranking of currency pairs/currencies to generate an ordered priority list of pairs/currencies. In other embodiments, the method may utilize one or more predictive algorithms to predict future priorities of currency pairs based on current and historical market data.

After generating all possible FX orders, the method may end. Alternatively, the method may continue to receive new or previous orders in step 502. That is, after performing step 538, the method may continuously re-execute the method illustrated in FIGS. 5A and 5B for new orders.

A first example of some embodiments of the methods is described below.

A client may manage a plurality of Accounts A, B, and C. Each account may be associated with a base currency. For example, Accounts A and B utilize USD (U.S. Dollars) as a base currency while Account C uses EUR (Euros) as a base currency.

As described previously, each account is associated with a target position due to security trades, currency hedging, etc. In this example, each account is associated a given point in time with the following positions:

TABLE 1

| | Account A | | Account B | | Account C | |
|---|---|---|---|---|---|---|
| Currency | Position | Base (USD) | Position | Base (USD) | Position | Base (EUR) |
| EUR | 1500 | −1680 | −200 | 224 | 0 | 0 |
| USD | 0 | 0 | 0 | 0 | 1000 | −892.8571429 |
| JPY | 0 | 0 | −50000 | 417.1185451 | −90000 | 672.8971963 |

Note that the conversions of currencies listed in Table 1 are based on theoretical market rates and are not intended to be limiting. In a simplistic scenario, the client may likewise set a priority for a plurality of currency pairs. As one example, the client may set a priority of one for the pairs EUR/USD and USD/JPY and two for the pair EUR/JPY. In one embodiment, a priority of one indicates that the currency pair has a higher priority over a priority of two, etc.

As one option, each currency position of each account may be analyzed and corresponding FX orders may be placed as summarized below:

TABLE 2

| | Side | CCY Pair | Quote CCY | Quantity |
|---|---|---|---|---|
| Account A | Buy | EUR/USD | USD | 1500 |
| Account B | Sell | EUR/USD | USD | 200 |
| Account B | Sell | USD/JPY | USD | 50000 |
| Account C | Buy | EUR/USD | EUR | 1000 |
| Account C | Sell | EUR/JPY | EUR | 90000 |

Using this option, each position for each account is reconciled resulting in the following allocations:

TABLE 3

| | Account | Account | Account |
|---|---|---|---|
| Currency Pair | A | B | C |
| EUR/USD | 1500 | −200 | −219.9599466 |
| USD/JPY | −1680 | 641.1185451 | 1000 |
| JPY/USD | 0 | −50000 | −90000 |

Note that internal allocations may be taken based on the differences between amounts in Table 3 and Table 1. In some embodiments, these internal nettings may be reported. Notably, this option does not utilize netting between currency pairs or between accounts and thus represents the most straight forward way to allocate FX orders.

As a second option, currency pairs are netted across accounts prior to reporting allocations. That is, each currency pair involved in reconciling the positions illustrated in Table 1 may be analyzed across each account to generate a combined currency pair position, as illustrated below:

TABLE 4

| | Account | Account | Account | |
|---|---|---|---|---|
| Currency | A | B | C | Totals |
| EUR/USD | 1500 | −200 | −892.8571429 | 407.1428571 |
| USD/JPY | 0 | 417.1185451 | 0 | 417.1185451 |
| EUR/JPY | 0 | 0 | 672.8971963 | 672.8971963 |

The system may then generate FX orders based on the combined totals across accounts:

TABLE 5

| Side | CCY Pair | Quote CCY | Quantity |
|---|---|---|---|
| Buy | EUR/USD | USD | 407.1428571 |
| Buy | USD/JPY | JPY | 417.1185451 |
| Buy | EUR/JPY | JPY | 672.8971963 |

Finally, the system reports the account allocations. Notably, Tables 4 and 5 illustrate netting across currency pairs only. As will be described herein, by netting currencies as well as currency pairs, the disclosed methods are able to further reduce the number and amounts of orders.

In a third embodiment, the methods net across account currencies. In this embodiment, the methods first net individual currency positions across all accounts. As discussed above, the numbers in Table 6 may be generated based on market rates at the time of netting.

TABLE 6

| | Account | Account | Account | |
|---|---|---|---|---|
| Currency | A | B | C | Totals |
| EUR | 1500 | −200 | −219.9599466 | 1080.040053 |
| USD | −1680 | 641.1185451 | 1000 | −38.88145491 |
| JPY | 0 | −50000 | −90000 | −140000 |

Note that as compared to Table 4, the netting in Table 6 is performed on a per-currency basis rather than a per-currency pair basis. After generating the combined currency positions across all accounts, any internalized account allocations may be reported before netted orders are generated. For example, the following table illustrates exemplary internalized account allocations reported prior to netting:

TABLE 7

| Currency | Account A | Account B | Account C |
|---|---|---|---|
| EUR | 419.9599466 | −200 | −219.9599466 |
| USD | −1641.118545 | 641.1185451 | 1000 |
| JPY | 0 | 0 | 0 |

As discussed supra, internalized allocations correspond to allocations that can be handled across accounts. For example, Account B and Account C's negative position with respect to EUR offsets Account A's position with respect to EUR. Thus, this netting may be handled internally without executing a market FX order.

Correspondingly, the remaining account positions, after reporting the internalized allocations, are as follows:

TABLE 8

| | Account | Account | Account | |
|---|---|---|---|---|
| Currency | A | B | C | Totals |
| EUR | 1080.040053 | 0 | 0 | 1080.040053 |
| USD | −38.88145491 | 0 | 0 | −38.88145491 |
| JPY | 0 | −50000 | −90000 | −140000 |

As can be seen, the positions of Account B and Account C with respect to EUR and USD are now zero as they are internally allocated from Account A′s position with respect to the same currency.

Next, the methods build high-priority currency pairs. Then the methods convert the largest possible quantities of the highest priority currency pairs to their absolute value USD equivalent, and choose the largest order. Finally, the methods adjust remaining currency positions, then continue generating orders in the same manner. Examples of these steps are provided below.

In a first iteration, the methods build the high-priority currency pairs:

TABLE 9

| Priority | Market Rate | Side | CCY Pair | Quote CCY | Quantity | Quantity (USD) |
|---|---|---|---|---|---|---|
| 1 | 1.1200 | Buy | EUR/USD | USD | 34.71558474 | 38.88145491 |
| 2 | 133.75 | Buy | EUR/JPY | JPY | 0 | 0 |

In Table 9, the methods identify the smallest dollar normalized amount. As illustrated in Table 8, the positions contain a significant long position in EUR and only a small short position in USD. Thus, the methods can only combine the short USD position with EUR as a short position against a short position (e.g., USD/JPY) cannot be combined. That is, the EUR/USD order is the largest order to go to market with.

Note that Table 9 illustrates a single high-priority currency pair (EUR/USD). However, in some situations, the method may generate many high-priority, non-overlapping currency pairs (e.g., EUR/JPY and USD/CAN). In this example, the method would select the currency pair that would generate the largest market order.

As illustrated above, two currency pairs were generated based on the account positions remaining after internalized allocations. From these three currency pairs, EUR/USD is initially selected since it has a higher priority (one) than EUR/JPY (two) and additionally results in a larger market order. Note that the examples illustrated in the Table 9 (and other tables) and herein utilized theoretical market rates and are not intended to be limited to a specific market rate. In one embodiment, a market rate represents the midpoint between bid and ask prices of a given currency/pair.

The highest quantity of EUR/USD represents the maximum amount of currency purchasable based on the combined account positions in Table 8. That is, since the absolute value of the EUR position times the market rate is greater than the absolute value of the USD position, the absolute value of the USD position divided by the market rate is the largest exchangeable quantity. If the absolute value of the EUR position times the market rate is less than the absolute value of the USD position, then the EUR position would be the largest exchangeable quantity.

Thus, the reported allocations for the higher priority orders would be:

TABLE 10

| | Account | Account | Account |
|---|---|---|---|
| Currency | A | B | C |
| EUR | 34.71558474 | 0 | 0 |
| USD | −38.88145491 | 0 | 0 |
| JPY | 0 | 0 | 0 |

After reporting the allocations, the remaining account positions are:

TABLE 11

| | Account | Account | Account | |
|---|---|---|---|---|
| Currency | A | B | C | Totals |
| EUR | 1045.324469 | 0 | 0 | 1045.324469 |
| USD | 0 | 0 | 0 | 0 |
| JPY | 0 | −50000 | −90000 | −140000 |

During a second iteration, the method performs the same operations on the second-level priority currency pair (EUR/JPY) (as discussed in more detail in FIG. 5B and the accompanying description). With the positions illustrated in Table 11, the netted FX orders are as follows

TABLE 12

| Priority | Market Rate | Side | CCY Pair | Quote CCY | Quantity | Quantity (USD) |
|---|---|---|---|---|---|---|
| 2 | 133.7500 | Buy | EUR/JPY | JPY | 1045.324469 | 1170.763405 |

As in Table 9, the largest order is a EUR/JPY buy for 1045.324469 and the reported allocations are thus:

TABLE 13

| Currency | Account A | Account B | Account C |
|---|---|---|---|
| EUR | 1045.324469 | 0 | 0 |
| USD | 0 | 0 | 0 |
| JPY | 0 | −50000 | −89812.14768 |

Thus, after this iteration, the position of all accounts is:

TABLE 14

| | Account | Account | Account | |
|---|---|---|---|---|
| Currency | A | B | C | Totals |
| EUR | 0 | 0 | 0 | 0 |
| USD | 0 | 0 | 0 | 0 |
| JPY | 0 | 0 | −187.8523162 | −187.8523162 |

At this point, no more currency pair orders may be generated from the remaining trade positions. The method may then finalize any remaining allocations by generating orders using account base currencies, netting with previously generated currency pairs when possible. In the case where the remaining allocations are already in an account's base currency, it is not necessary to generate any orders. As discussed above, Account C's base currency is EUR, thus the following order may be generated:

TABLE 15

| Priority | Market Rate | Side | Ccy Pair | Quote Ccy | Quantity | Quantity (USD) |
|---|---|---|---|---|---|---|
| N/A | 133.7500 | Buy | EUR/JPY | JPY | 1.404503299 | 1.573043695 |

The corresponding allocations would thus be:

TABLE 16

| Currency | Account A | Account B | Account C |
|---|---|---|---|
| EUR | 0 | 0 | 1.404503299 |
| USD | 0 | 0 | 0 |
| JPY | 0 | 0 | −187.8523162 |

At this point, the netted orders and the remaining orders may be combined into a final set of orders:

TABLE 17

| | | |
|---|---|---|
| Buy | EUR/USD | 35 |
| Buy | EUR/JPY | 1047 |

Notably, the EUR/USD corresponds to the first netted order illustrated in Table 9. The EUR/JPY corresponds to the second netted order in Table 12 as well as the non-netted order illustrated in Table 15.

Note that in some embodiments, the methods may not execute the orders generated in Table 17 based on the allocations in Table 16. In some embodiments, the method may retain these orders and await future orders to net these orders with future orders generated. In other embodiments, the method may alternatively cross any remaining positions through the dollar as discussed in FIG. 5B. In some embodiments, the remaining positions may be suitably small such that they may be ignored, discarded, or written off given the small nature of the remaining positions.

As illustrated in the above examples, by using the netting methods described in FIGS. 5A through 5B, the disclosed embodiments substantially decrease the number of trades needed to hedge or cover exposure of many security trades. For example, Table 2 illustrates that six buy and sell orders are necessary to reconcile the exposure illustrated in Table 1. By contrast, Tables 5 and 17 for example, the number of orders are substantially reduced to three and two orders, respectively. Additionally, by reducing the number of FX orders, the methods described above reduce market impact of managing a customer's FX exposure of hedging. Specifically, but sending larger, netted orders, the method avoids inadvertently flooding an exchange market with orders which may drive up (or down) currency exchanges rates. Additionally, the method also ensures that a firm only must go to market when necessary. That is, by netting orders, the methods reduce the total number of orders by internalizing orders where possible. Additionally, the method lowers transaction costs associated with a firm's currency activities.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A system comprising:
an application cluster;
at least one database communicatively coupled to the application cluster;
a machine image database, the machine image database storing a plurality of machine images for deployment in the application cluster; and
an auto-scaler coupled to the machine image database, the auto scaler configured to select a machine image from the machine image database and instantiate a virtual machine in the application from the selected machine in response to a monitored computing load of the application cluster, wherein a virtual machine comprises:
a market rate service configured to periodically receive current market rates,
an exposure tracker configured to receive a plurality of transactions from a plurality of client systems via a plurality of protocols, and
an order generator configured to:
build one or more currency pair positions based on the transactions,
break down each of the currency pair positions into individual currency positions,
net the individual currency positions,
identify a plurality of high-priority currency pairs based on the netted individual currency positions,
convert the high-priority currency pairs to an absolute value equivalent using current market rates,
identify a largest absolute value equivalent of the high-priority currency pairs,
generate a foreign exchange order for the largest absolute value equivalent and
execute the foreign exchange order and store the foreign exchange order in the one or more databases.

2. The system of claim 1, wherein breaking down each of the currency pair positions into individual currency positions further comprises generating one or more hedged currency positions.

3. The system of claim 2, wherein the hedged currency positions comprise alternative currency positions to generate based on an underlying individual currency position, the alternative currency positions are generated based on a hedging strategy defined by a customer.

4. The system of claim 1, wherein the generating a foreign exchange order for the largest absolute value equivalent further comprises generating a foreign exchange order based on one or more high-value currencies remaining in the individual currency positions.

5. The system of claim 1, wherein generating a foreign exchange order based on one or more high-value currencies remaining in the individual currency positions further comprises generating a plurality of foreign exchange orders for any remaining individual currency pairs.

6. The system of claim 5, wherein the order generator is further configured to:
identify any remaining individual currency positions; and
generate additional currency pairs by crossing each remaining individual currency position through a common currency.

7. The system of claim 5, wherein the order generator is further configured to:
identify any remaining individual currency positions; and
discard the remaining individual currency positions.

8. The system of claim 1 wherein the logic for building one or more currency pair positions based on the transactions the method further comprises logic for determining whether one or more exposure evaluation criteria are met.

9. The system of claim 8, wherein the exposure evaluation criteria comprise one or more of schedule, condition-based, manual, cash repatriation, and external triggers.

10. The system of claim 1, wherein netting the individual currency positions comprises performing an internalized netting operation to net the individual currency positions across accounts.

11. A method comprising:
receiving a plurality of transactions;
building one or more currency pair positions based on the transactions;
breaking down each of the currency pair positions into individual currency positions;
netting the individual currency positions;
identifying a plurality of high-priority currency pairs based on the netted individual currency positions;
converting the high-priority currency pairs to an absolute value equivalent using current market rates;
identifying a largest absolute value equivalent of the high-priority currency pairs;
generating a foreign exchange order for the largest absolute value equivalent; and
executing the foreign exchange order.

12. The method of claim 11, wherein breaking down each of the currency pair positions into individual currency positions further comprises generating one or more hedged currency positions.

13. The method of claim 12, wherein the hedged currency positions comprise alternative currency positions to generate based on an underlying individual currency position, the alternative currency positions are generated based on a hedging strategy defined by a customer.

14. The method of claim 11, wherein after generating a foreign exchange order for the largest absolute value equivalent the method further comprises generating a foreign exchange order based on one or more high-value currencies remaining in the individual currency positions.

15. The method of claim 11, wherein after generating a foreign exchange order based on one or more high-value currencies remaining in the individual currency positions the method further comprises generating a plurality of foreign exchange orders for any remaining individual currency pairs.

16. The method of claim 15, further comprising:
identifying any remaining individual currency positions; and
generating additional currency pairs by crossing each remaining individual currency position through a common currency.

17. The method of claim 15, further comprising
identifying any remaining individual currency positions; and
discarding the remaining individual currency positions.

18. The method of claim 11 wherein prior to building one or more currency pair positions based on the transactions the method further comprises determining whether one or more exposure evaluation criteria are met.

19. The method of claim 18, wherein the exposure evaluation criteria comprise one or more of schedule, condition-based, manual, cash repatriation, and external triggers.

20. The method of claim 11, wherein netting the individual currency positions comprises performing an internalized netting operation to net the individual currency positions across accounts.
